(19) United States
(12) Patent Application Publication
(10) Pub. No.: US 2008/0231195 A1
(43) Pub. Date: Sep. 25, 2008

(54) Headlight control device

(75) Inventors: Kenji Kobayashi, Nagoya (JP); Yukimasa Tamatsu, Okazaki-shi (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/077,182

(22) Filed: Mar. 17, 2008

(30) Foreign Application Priority Data
Mar. 19, 2007 (JP) 2007-071212

(51) Int. Cl. B60Q 1/08

(52) U.S. Cl. 315/82

(57) ABSTRACT

In a vehicle headlight apparatus, a projection unit having a same structure of an LED projector receives a light provided from a lamp. The projection unit generates and projects a projection image toward a vehicle front-area. A vehicle ECU has an image signal obtaining means for obtaining image signals representing a vehicle front-area image, a high brightness area determination means for analyzing the image signals in order to successively determine a high brightness area in the image signals, and a projection image determination means for determining a projection image so that the light, corresponding to the high brightness area and to be irradiated toward the vehicle front-area, becomes weak when compared with the light previously determined. Thereby, an intensity of the light to be irradiated to an object with a high reflection factor can be decreased. This can suppress decreasing of driver's frontal visibility.

### CROSS-REFERENCE TO RELATED APPLICATION

This application is related to and claims priority from Japanese Patent Application No. 2007-71212 filed on Mar. 19, 2007, the contents of which are hereby incorporated by reference.

### BACKGROUND OF THE INVENTION

1. Field of the Invention

The present invention relates to a headlight control device to be installed in a vehicle headlight apparatus utilizing a projector device for motor vehicles.

2. Description of the Related Art

There is known a vehicle headlight apparatus that utilizes a projector device. For example, Japanese patent laid open publication No. JP 2004-136838 has disclosed such a vehicle headlight apparatus utilizing a transmission type liquid crystal projector device. In the vehicle headlight apparatus, a light source irradiates a light into a liquid crystal panel. The light is then projected to a front area of a vehicle through one or more lenses.

In the vehicle headlight apparatus disclosed in JP 2004-136838, a predetermined optical image is formed in the liquid crystal panel in order to control a propagation direction and a range of a high beam light and a low beam light as well as a color of the light.

In the related-art technique disclosed in JP 2004-136838, when a car navigation system makes information regarding a current vehicle position and a vehicle moving direction, the vehicle headlight apparatus displays such information on a road. The vehicle headlight apparatus further displays other information, for example, an arrow mark on a road, which indicates the direction of left-turn when a driver instructs the left-turn to the vehicle.

By the way, when a headlight apparatus irradiates a high beam light onto a distant area on the road, the driver's frontal visibility generally increases. However, there is a possibility of there being things with a high reflection factor on the road in a front area of the moving vehicle, such as signboards, traffic signs, preceding vehicles, oncoming vehicles, or pedestrians with reflection tape. Those things often reflect light irradiated from headlight lamps of the vehicle toward the direction of the vehicle driver. This situation decreases the driver's frontal visibility.

In the related-art techniques, the driver switches to the low beam light from the high beam light when the driver's frontal visibility decreases.

Although there is a similar possibility of the drivers frontal visibility decreasing when the headlight apparatus irradiates a high beam light, the vehicle headlight apparatus utilizing a projector device has an advantage in that it can change a headlight irradiation range and a headlight color.

### SUMMARY OF THE INVENTION

It is an object of the present invention to provide a headlight control device, that utilizes a feature of a projector type vehicle headlight apparatus, capable of suppressing any decrease of a driver's frontal visibility even if a high reflection object is present in a front area of a vehicle.

To achieve the above purposes, the present invention provides a headlight control device to be installed to a vehicle headlight apparatus. Such a vehicle headlight apparatus is comprised of a light source and a projection unit which receives a light provided from the light source and generates a projection image using the received light and projects the image toward a front area of a vehicle.

In particular, the headlight control device has an image signal obtaining means, a high brightness area determination means, and a projection image determination means. The image signal obtaining means successively obtains image signals which represent a front area image of a vehicle provided from a vehicle-mounted camera when a projection image is projected toward a front area of the vehicle. The high brightness area determination means analyses the image signals obtained by the image signal obtaining means, and successively determines a high brightness area in the image signals. The projection image determination means determines a projection image to be transmitted to and generated in the projection unit.

The image signal can be broken into information concerning brightness levels, and this is determined by the light brightness area determination means. The strength of the light to be irradiated toward the front area of the vehicle can then be made to be weaker, taking into account the areas of high brightness in the image signals, resulting in a weaker light.

According to the present invention, the front area image of the vehicle is analyzed in order to determine the high brightness area in the image signals. Further, the projection image is determined so that the light to be irradiated to the front area of the vehicle corresponding to the high brightness area becomes weak. Accordingly, even if a vehicle driver is temporarily dazzling reflections of the light from an object of a high reflection factor such as a traffic sign, the intensity of the light to be irradiated to the object is decreased by determining the area including the object as the high brightness area. Because this can decrease the intensity of the reflected light from the object, it is possible to suppress any lessening of the driver's frontal visibility.

There is another approach in decreasing the intensity of light to be irradiated to the front area of the vehicle corresponding to the high brightness area. That is, in the vehicle control device, as another aspect of the present invention, the projection image determination means determines the high brightness range in the projection image which corresponds to the light brightness area in the image signals, and then determines a range of brightness in the projection image so that the brightness range does not include the high brightness range in the projection image.

The present invention provides another following modification. The projection image determination means determines the projection image so that an upper limit of the bright range is lower than a lower limit of the high brightness range in the projection image.

The present invention also provides another following modification. The projection image determination means determines the projection image so that the bright range becomes a range obtained by eliminating and replacing the high brightness range in the projected image with the brightness range taken from the previously taken image signals.

The former modification can decrease calculation load because the upper limit of the range of brightness in the projection image is only switched to the lower limit. On the contrary, in the latter modification, it is possible to keep the driver's frontal visibility because a high beam light can be maintained.

The present invention provides another approach to decrease the intensity of light corresponding to the high brightness area, to be irradiated to the front area of the vehicle. That is, in the headlight control device as another aspect of the present invention, the projection image determination means determines the high brightness range in the projection image which corresponds to the light brightness area in the image signals, and then determines a color of the high brightness range in the projection image so that the color becomes a low brightness color when compared with that of the previous projection image.

In this approach, because the vehicle headlight apparatus irradiates the light to the object of a high reflection factor which is present in a front area of the vehicle corresponding to the high brightness area so that the driver is not dazzling reflections of the light from the object, it is possible to enhance the driver's frontal visibility to the object.

When the color light is switched, it is preferable that the projection image determination means determines the brightness of the color of the high brightness range in the projection image so that the brightness of the high brightness area determined by the high brightness area determination means becomes lower than a reference brightness which is determined in advance. This can decrease the intensity of the reflection light, reflected from the object which is present in the front area of the vehicle, corresponding to the high brightness area, to a low intensity, so that the driver is not dazzling reflections of the light from the object.

### BRIEF DESCRIPTION OF THE DRAWINGS

A preferred, non-limiting embodiment of the present invention will be described by way of example with reference to the accompanying drawings, in which:

FIG. 1 shows a schematic configuration of a vehicle headlight apparatus equipped with a headlight ECU according to an embodiment of the present invention;

FIG. 2 shows an example of a front image of a vehicle represented by image signals obtained by the headlight ECU shown in FIG. 1, and in particular, shows a high brightness area in the image; and

FIG. 3 is a flow chart showing a method of controlling a projection image by the headlight ECU according to the present invention.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Embodiment

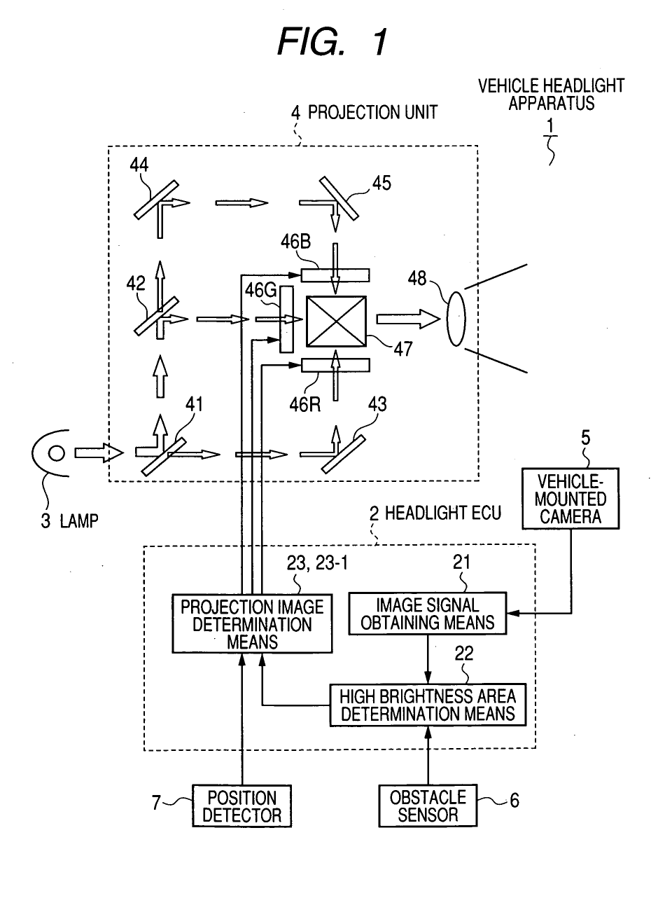

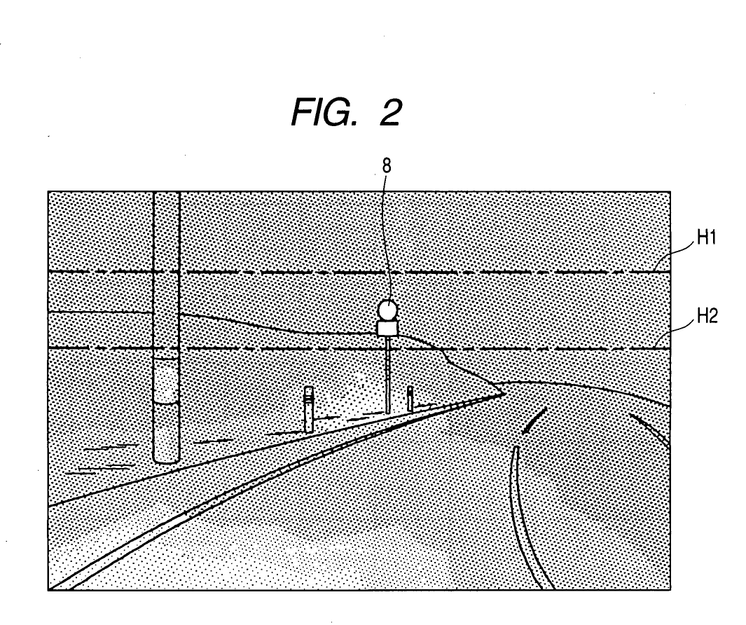

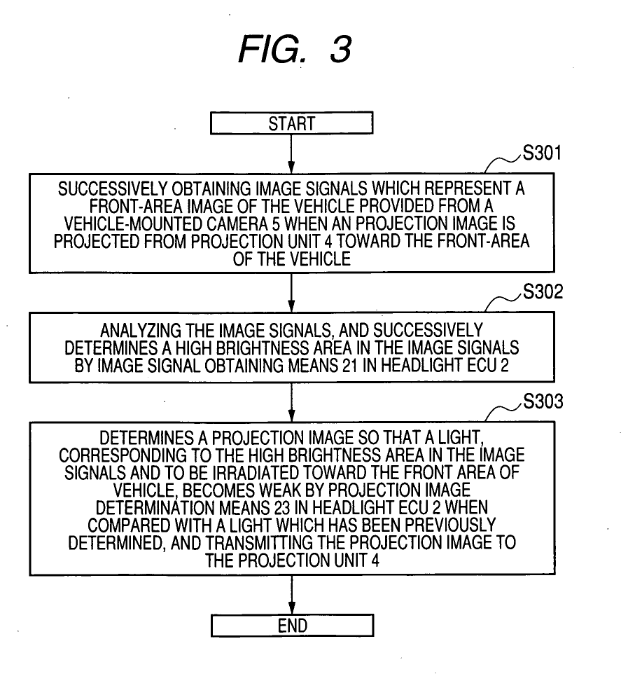

A description will be given of a headlight electric control unit 2 (hereinafter, referred to as the “headlight ECU 2” for short) as a headlight control device according to a first embodiment of the present invention with reference to FIG. 1, FIG. 2, and FIG. 3. The headlight ECU 2 as the headlight control device according to the present invention is installed to a vehicle headlight apparatus 1.

FIG. 1 shows a schematic configuration of the vehicle headlight apparatus 1 equipped with the headlight ECU 2 according to the first embodiment of the present invention.

As shown in FIG. 1, the vehicle headlight apparatus 1 is comprised of a lamp 3 as a light source, a projection unit 4, and the headlight ECU 2. Although FIG. 1 shows only the lamp 3 and the projection unit 4, an actual vehicle is equipped with a pair of the lamps 3 (a right headlamp and a left headlamp) and a pair of the projection units 4 (as a right projection unit and a left projection unit). A pair of the lamps 3 and a pair of the projection units are disposed at a front end part of a vehicle.

In the embodiment, well-known various types of lamps such as a halogen lamp and a xenon lamp are available as the lamp 3. The headlight ECU 2 performs On/Off control of the lamp 3.

The projection unit 4 in the vehicle headlight apparatus 1 has a same structure of a projection unit in an available transmission type liquid crystal projector. That is, the projection unit 4 is comprised of a primary dichroic mirror 41, a secondary dichroic mirror 42, a first mirror 43, a second mirror 44, a third mirror 45, a red color liquid crystal panel 46R, a green color liquid crystal panel 46G, a blue color liquid crystal panel 46B, a prism 47, and a projection lens 48.

The primary dichroic mirror 41 is capable of selectively reflecting green light and blue light, and on the contrary, capable of transmits red color.

On the other hand, the secondary dichroic mirror 42 is capable of selectively reflecting green light and capable of transmits red light and blue light. The primary dichroic mirror 41 and the secondary dichroic mirror 42 are disposed in the projection unit 4 so that the secondary dichroic mirror 42 faces a reflection surface of the primary dichroic mirror 41.

Green light and blue light reflected by the primary dichroic mirror 41 come to the secondary dichroic mirror 42.

The secondary dichroic mirror 42 transmits blue light and reflects green light toward the prism 47.

The first mirror 43 completely reflects toward the prism 47 light (namely, red light) transmitted through the primary dichroic mirror 41.

The second mirror 44 completely reflects toward the third mirror 45 light (namely, blue light) transmitted through the secondary dichroic mirror 42.

The third mirror 45 completely reflects light transmitted from the second mirror 44 toward the prism 47.

The red color liquid crystal panel 46R generates various types of images (optical images) under the control of the headlight ECU 2. The red color liquid crystal panel 46R is disposed between the first mirror 43 and the prism 47. Red color light provided from the first mirror 43 transmits through the red color liquid crystal panel 46R, and a red color image thereby enters into the prism 47.

The green color liquid crystal panel 46G also generates various types of images (optical images) under the control of the headlight ECU 2. The green color liquid crystal panel 46G is disposed between the secondary dichroic mirror 42 and the prism 47. Green color light provided from the secondary dichroic mirror 42 transmits through the green color liquid crystal panel 46G, and a green color image thereby enters into the prism 47.

The blue color liquid crystal panel 46B generates various types of images (optical images) under the control of the headlight ECU 2. The blue color liquid crystal panel 46B is disposed between the third mirror 45 and the prism 47. Blue color light provided from the third mirror 45 transmits through the blue color liquid crystal panel 46B, and a blue color image thereby enters into the prism 47.

The prism 47 receives the red color image provided from the red color liquid crystal panel 46R, the green color image provided from the green color liquid crystal panel 46G, and the blue color image provided from the blue color liquid crystal panel 46B, and then synthesizes those images to generate a projection image. The prism 47 then projects the projection image toward the projection lens 48.

When each of the liquid crystal panels 46R, 46G, and 46B provides no image, the projection image becomes a white color image that represents only an outline determined by each of the liquid crystal panels 46R, 46G, and 46B.

The projection lens 48 magnifies the light provided from the prism 47, and projects the magnified light toward the front area of a vehicle. As a result, the projection image synthesized by the prism 47 is magnified and the magnified projection image is projected toward the front area of a vehicle.

In the embodiment, a size and shape of the projection lens 48 is determined so that the irradiation range of a projection image to be projected toward the front area of a vehicle can cover all of an irradiation range on a high beam light and an irradiation range on a low beam light.

The headlight ECU 2 is a computer system equipped with a central processing unit (CPU), a read only memory (ROM), a random access memory (RAM), and the like. The headlight ECU 2 executes programs using a temporary memory in the RAM. Those programs are stored in advance in the ROM. That is, the headlight ECU 2 serves as an image signal obtaining means 21, a high brightness area determination means 22, and a projection image determination means 23.

FIG. 3 is a flow chart showing a method of controlling a projection image by means of the headlight ECU 2 according to the present invention. In the vehicle headlight apparatus 1, the headlight ECU 2 generates the projection image and transmits the generated one to the projection unit 4. The projection unit 4 irradiates a light based on the projection image transmitted from the headlight ECU 2.

The image signal obtaining means 21 obtains image signals provided from a vehicle-mounted camera 5 every predetermined period of time when the projection unit 4 projects a projection image toward the vehicle front area (step S301).

The vehicle-mounted camera 5 is capable of scanning an image of the vehicle front area. A position and a scanning range of the vehicle-mounted camera 5 are set in advance in order to photograph the entire of the projection image regardless of a size and a range of the projection image. For example, the vehicle-mounted camera 5 is disposed at a vehicle compartment ceiling.

The high brightness area determination means 22 receives the image signals transferred from the image signal obtaining means 21, and then analyses the image signals, and successively determines a high brightness area in the image signals (step S302). For example, there is a following analyzing method of determining the high brightness area in the image signals.

A brightness value of each pixel in the image signals corresponding to the vehicle front area is determined. Binary processing is carried out in order to obtain the brightness value of each pixel in the image signals based on a reference brightness value that has been determined in advance. According to a well-known labeling method, the area, whose brightness value is not less than a reference brightness value, is extracted.

Instead of using such a labeling method, it is also possible to judge that a brightness value of each pixel is within a high brightness area or not.

FIG. 2 shows an example of the vehicle front-area image represented by image signals obtained by the headlight ECU 1 shown in FIG. 1. In particular, FIG. 2 shows a traffic sign 8 as the high brightness area in the image.

In the case shown in FIG. 2, the headlight ECU 2 according to the present invention determines the traffic sign 8 as the high brightness area. It is also possible that the headlight ECU 2 receives detection signals provided from an obstacle sensor 6 (see FIG. 1), and estimates a relative distance between the obstacle and the vehicle, and then limits a range for the image analyzing to a part of the vehicle front-area image based on the estimation result before initiating the image analyzing by the headlight ECU 2. A millimeter band radar sensor and a laser radar sensor are available as the obstacle sensor 6.

The projection image determination means 23 successively determines a projection image which will be projected by the projection unit 4 so that a light is not irradiated to the area in the vehicle front area, corresponding to the high brightness area determined by the high brightness area determination means 22 (step S303). The projection image determination means 23 then controls the operation of the red color image provided from the red color liquid crystal panel 46R, the green color image provided from the red color liquid crystal panel 46G, and the blue color image provided from the red color liquid crystal panel 46B in the projection unit 4 in order to correctly generate the determined projection image (step S303).

In case of the example shown in FIG. 2, the projection image determination means 23 successively determines the projection image so that the light is not irradiated to the traffic sign 8.

In order not to irradiate the light to the traffic sign 8, the range in the projection image corresponding to the traffic sign 8 (namely, the high brightness area in the vehicle front-area image) is eliminated from a bright range. In the embodiments of the present invention, the bright range is defined as the range in the projection image that is generated by the light provided from the lamp 3 as the light source, and then transmits through at least one of the red color liquid crystal panel 46R, the green color image provided from the red color liquid crystal panel 46G, and the blue color image provided from the red color liquid crystal panel 46B in the projection unit 4.

Although the high brightness range in the projection image is determined within a range corresponding to the high brightness area in the vehicle front-area image, it is possible to determine a wider range so long as it includes the range corresponding to the high brightness area.

There is another preferred modification to eliminate the high brightness range from the bright range in the projection image, in which an upper limit of the bright range in the projection image is changed to a lower side rather than the bottom limit of the high brightness range in the projection image. In this case, as shown in FIG. 2, the upper limit of the irradiation range of the light is switched from the line H1 to the line H2. That is, the upper limit of the bright range is switched.

Further, there is another preferred modification to determine the range of brightness by subtracting the high brightness range in the projection image from a range of brightness in a previous projection image before determining the traffic sign 8 as the high brightness area. In case of this modification, because a high beam light of the vehicle can be continued, it is possible to keep the driver's frontal visibility. However, because a relative position between a surrounding object and the vehicle are successively changed when the vehicle moves, the high brightness range in the projection image is also changed. Accordingly, in case of this modification, there is a need to successively determine the high brightness range in the projection image.

In order to satisfy this demand, the projection image can be successively analyzed. Instead, it is also possible to calculate a difference of the relative position between the surrounding object and the vehicle based on the current position of the vehicle that is successively detected by a position detector 7, and to change the high brightness range in the projection image based on the change of the calculated relative position.

As described above, according to the first embodiment of the present invention, the high brightness area is successively determined by analyzing the image of the vehicle front area provided from the vehicle-mounted camera 5, and the projection image is determined so that the light is not irradiated to a part in the vehicle front area corresponding to the high brightness area.

As a result, even if the vehicle driver is temporarily dazzling reflections of the light from the object of a high reflection factor such as the traffic sign 8 shown in FIG. 2, because the headlight ECU 2 in the headlight apparatus 1 determines the area including the object with the high reflection factor as the high brightness area, and provides the light of low brightness to the object with a high reflection factor, the intensity of the reflection light from the object with a high reflection factor becomes weak. This can suppress the decrease of the driver's frontal visibility

### Second Embodiment

A description will be given of the vehicle headlight apparatus 1 equipped with the headlight ECU 2 according to a second embodiment of the present invention.

The second embodiment according to the present invention will explain a modification 23-1 of the projection image determination means in the headlight ECU 2 in the vehicle headlight apparatus 1. Because other components of the second embodiment are the same as those in the first embodiment, the explanation of the same components is omitted here.

The projection image determination means 23-1 decreases the brightness of the high brightness area to a value of not more than a reference brightness value by changing to a dark color in the range of the high brightness range in the projection image.

Specifically, like the first embodiment, the high brightness area determination means 22 receives image signals provided from the image signal obtaining means 21, and then determines the range of a high brightness range in a projection image corresponding to a high brightness area in the image signals of the vehicle front area.

In the second embodiment, it is possible to determine a wide range for the high brightness range in the projection image so long as it includes the range corresponding to the high brightness area in the image signals of the vehicle front area. For example, it is acceptable to determine the range that covers all areas whose coordinates are the same in vertical direction of those of the high brightness range. This case determines a belt shaped range in the projection image.

Next, the projection image determination means 23-1 determines a more dark color in the high brightness range in the projection image when compared with a color in a previous projection image.

It is possible to use a predetermined dark color whose brightness is determined in advance, or possible to decrease the brightness of such a dark color according to a difference between the brightness value in the high brightness area in the image signals of the vehicle front area and a reference brightness value.

In the former case, there is a possibility of not adequately decreasing the brightness of the image in the vehicle front area by changing once the color of the high brightness range in the projection image. In this case, a color in the high brightness range in the projection image is changed several times.

When the color in the high brightness range in the projection image is changed to a more dark-brightness color, the light transmitting through the high brightness range in the projection image becomes weak. As a result, the vehicle headlight apparatus 1 can irradiate the light to an object in the vehicle front area, corresponding to the high brightness area so that the vehicle driver is not dazzling reflections of the light from the object. This can suppress decrease of the driver's frontal visibility. Because headlights also irradiate the light to such an object in front of the vehicle, the driver's frontal visibility to the object also increases.

The present invention is not limited by the first and second embodiments. It is possible to apply the concept of the present invention to various applications within the scope of the present invention. For example, although the projection unit 4 has a same structure of a transmission type liquid crystal projector, it is possible that the projection unit 4 in the vehicle headlight apparatus has a same structure of another type of projectors such as a DLP (digital light processing) projector and a CRT projector.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. A headlight control device for a vehicle headlight apparatus comprising a light source and a projection unit, in which the projection unit receives the light provided from the light source, and generates a projection image using the received light and projects the image toward a front area of a vehicle,
the headlight control device comprising:
image signal obtaining means that successively obtains image signals representing a front area image of a vehicle provided from a vehicle-mounted camera when a projection image is projected toward a front area of the vehicle;
high brightness area determination means that analyses the image signals obtained by the image signal obtaining means, and successively determines a high brightness area in the image signals; and
projection image determination means that determines a projection image to be transmitted to and generated in the projection unit so that the light, corresponding to the high brightness area in the image signals determined by the high brightness area determination means, to be irradiated toward a front area of the vehicle becomes weak when compared with the light which is previously determined.

2. The headlight control device according to claim 1, wherein the projection image determination means determines the high brightness range in the projection image which corresponds to the light brightness area in the image signals, and then determines a bright range in the projection image so that the bright range does not include the high brightness range in the projection image.

3. The headlight control device according to claim 2, wherein the projection image determination means determines the projection image so that an upper limit of the bright range is lower than a lower limit of the high brightness range in the projection image.

4. The headlight control device according to claim 2, wherein the projection image determination means determines the projection image so that the bright range becomes a range obtained by eliminating the high brightness range in the projection image from the bright range in the previous projection image which is obtained immediately before.

5. The headlight control device according to claim 2, wherein the projection image determination means determines the high brightness range in the projection image which corresponds to the light brightness area in the image signals, and then determines a color of the high brightness range in the projection image so that the color becomes a low brightness color when compared with that of the previous projection image.

6. The headlight control device according to claim 5, wherein the projection image determination means determines the brightness of the color of the high brightness range in the projection image so that the brightness of the high brightness area determined by the high brightness area determination means becomes lower than a reference brightness which is determined in advance.

7. A method of controlling a projection image to be projected by a vehicle headlight apparatus comprised of a light source and a projection unit, wherein the projection unit receives a light provided from the light source and generates a projection image using the light and projects the projection image toward a front area of a vehicle,
the method of comprising steps of:
successively obtaining image signals which represents a front area image of the vehicle provided from a vehicle-mounted camera when an projection image is projected toward the front area of the vehicle;
analyzing the image signals, and successively determines a high brightness area in the image signals; and
determines a projection image so that the light, corresponding to the high brightness area in the image signals and to be irradiated toward the front area of the vehicle, becomes weak when compared with the light which has been previously determined, and transmitting the projection image to the projection unit.

8. The method of controlling a projection image according to claim 7, wherein the high brightness range in the projection image which corresponds to the light brightness area in the image signals is determined, and then a bright range in the projection image is determined so that the bright range does not include the high brightness range in the projection image.

9. The method of controlling a projection image according to claim 8, wherein the projection image is determined so that an upper limit of the bright range is lower than a lower limit of the high brightness range in the projection image.

10. The method of controlling a projection image according to claim 8, wherein the projection image is determined so that the bright range becomes a range obtained by eliminating the high brightness range in the projection image from the bright range in the previous projection image which is obtained immediately before.

11. The method of controlling a projection image according to claim 8, wherein the high brightness range in the projection image which corresponds to the light brightness area in the image signals is determined, and a color of the high brightness range in the projection image is determined so that the color becomes a low brightness color when compared with that of the previous projection image.

12. The method of controlling a projection image according to claim 11, the brightness of the color of the high brightness range in the projection image is determined so that the brightness of the high brightness area becomes lower than a reference brightness which is determined in advance.
